(19) United States
(12) Patent Application Publication
(10) Pub. No.: US 2015/0159810 A1
(43) Pub. Date: Jun. 11, 2015

(54) SUSPENDED PRESSURE RELIEF RUPTURE DISC

(71) Applicants: David Leonard, Yavneil (IL); Gilad Doron, Moledet (IL)

(72) Inventors: David Leonard, Yavneil (IL); Gilad Doron, Moledet (IL)

(21) Appl. No.: 14/101,430

(22) Filed: Dec. 10, 2013

(51) Int. Cl. F17C 13/04; F16K 17/16

(52) U.S. Cl. CPC F17C 13/04; F16K 17/16; F17C 2205/0332

(57) ABSTRACT

A pressure relief device includes a rupture disc installed in a housing disposed on a pressure vessel chamber, and a flow restrictor placed between the pressure vessel chamber and the rupture disc.

### CROSS-REFERENCE TO OTHER APPLICATIONS This application claims priority from U.S. Provisional Patent Application 61/735078, filed Dec. 10, 2012.

### FIELD OF THE INVENTION

The present invention relates generally to a safety structure element commonly used in pressure vessels of a pressurized heat engine, such as in Stirling engines, and particularly to a safety structure element which is in the form of a rupture disc.

### BACKGROUND OF THE INVENTION

There are many types of thermal engines, such as but not limited to, Stirling engines, that utilize a working fluid at relatively high pressure in a working fluid chamber. It is common to use safety vents to protect against over-pressure conditions.

One known safety vent is a rupture disc. FIG. 1 shows an example of a prior art pressure relief device. The device has a rupture disc 1, which is a frangible member that ruptures in the presence of an over-pressure condition. The assigned rupture point enables a defined pressure relief, which protects the pressure vessel elements from failure. The device is shown attached to a pressure vessel wall 4 of a pressure vessel volume chamber 5.

However, the sudden pressure relief of the prior art rupture disc may be hazardous for a pressure vessel that contains several internal volume chambers. The immediate pressure drop at the main volume chamber 5 may create a high pressure difference with respect to adjacent chambers or volumes, and cause failure of structural parts, which are not normally designed to withstand such high pressure as the main chamber or volume.

Another problem can occur with the rupture disc operating under fluctuating pressure conditions. The common rupture disc type will tear at the highest pressure level in the chamber, i.e. mean pressure plus the amplitude pressure component. This unfortunately dictates a higher pressure rating on the rupture disc, increasing the design pressure of the vessel.

### SUMMARY OF THE INVENTION

The present invention seeks to provide a novel pressure relief device, as is explained more in detail hereinbelow, which solves the abovementioned problems of the prior art.

There is thus provided in accordance with a non-limiting embodiment of the invention a pressure relief device including a rupture disc installed in a housing disposed on a pressure vessel chamber, and a flow restrictor placed between the pressure vessel chamber and the rupture disc.

### BRIEF DESCRIPTION OF THE DRAWINGS

The present invention will be understood and appreciated more fully from the following detailed description taken in conjunction with the drawings in which:

FIG. 1 is a simplified illustration of a prior art pressure relief device; and

FIG. 2 is a simplified illustration of a pressure relief device, constructed and operative in accordance with an embodiment of the present invention.

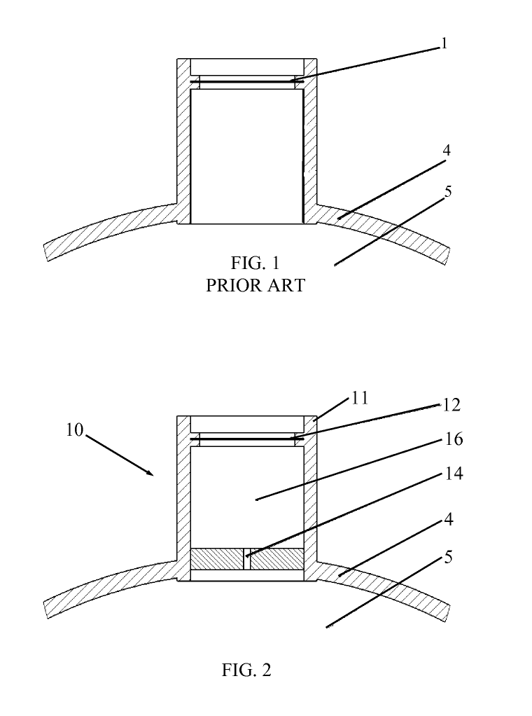

### DETAILED DESCRIPTION OF EMBODIMENTS

Reference is now made to FIG. 2, which illustrates a pressure relief device 10, constructed and operative in accordance with a non-limiting embodiment of the present invention.

The pressure relief device 10 has a rupture disc 12 installed in a housing 11. Rupture disc 12 is a frangible member that ruptures in the presence of an over-pressure condition. Similar to the prior art device, device 10 is shown attached to a pressure vessel wall 4 of a pressure vessel volume chamber 5. In one embodiment, chamber 5 is the pressure containment vessel of an oscillating heat engine, such as Stirling engine.

The pressure relief device 10 differs from the prior art device in that the invention includes a flow restrictor (e.g., orifice) 14, placed between the pressure vessel chamber 5 and the rupture disc 12. The flow restrictor 14 solves at once both of the above mentioned problems. First, after rupture disc 12 bursts, the pressure is released gradually (e.g., gradiently) as the escaping gas must first travel through a restricting orifice or channel, enabling a pressure equalization of the internal volumes without failure of the internal partitions. Second, the flow restrictor 14 restricts the flow to a mean pressure chamber 16 between the flow restrictor 14 and the rupture disc 12, which means that the oscillating flow and pressure is damped and the rupture disc 12 is subjected only to the vessel's mean pressure.

Other examples of flow restrictors which may be used include an orifice, capillary tube, porous material, and others.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A pressure relief device comprising:
a rupture disc installed in a housing disposed on a pressure vessel chamber, said rupture disc being a frangible member that ruptures in a presence of an over-pressure condition in said pressure vessel chamber; and
a flow restrictor placed between said pressure vessel chamber and said rupture disc.

2. The pressure relief device according to claim 1, wherein said flow restrictor restricts fluid flow to a mean pressure chamber located between said flow restrictor and said rupture disc.

3. The pressure relief device according to claim 1, wherein said pressure vessel chamber is a chamber of a heat engine comprising an operating fluid at an elevated pressure.

4. The pressure relief device according to claim 1, wherein said flow restrictor comprises an orifice.

5. The pressure relief device according to claim 1, wherein said flow restrictor comprises a capillary tube.

6. The pressure relief device according to claim 1, wherein said flow restrictor comprises a porous material.

7. A method for relieving pressure in a pressure vessel chamber comprising:
having a rupture disc installed in a housing disposed on a pressure vessel chamber, said rupture disc being a frangible member that ruptures in a presence of an over-pressure condition in said pressure vessel chamber, and wherein a flow restrictor is placed between said pressure vessel chamber and said rupture disc; and
relieving pressure in said pressure vessel chamber by said rupture disc rupturing in a presence of an over-pressure condition in said pressure vessel chamber.

8. The method according to claim 7, wherein after said rupture disc bursts, the pressure in said pressure vessel chamber is released gradually as escaping gas first travels through said flow restrictor.

9. The method according to claim 7, wherein said flow restrictor restricts fluid flow to a mean pressure chamber located between said flow restrictor and said rupture disc.
